(19) United States
(12) Patent Application Publication
(10) Pub. No.: US 2006/0163889 A1
(43) Pub. Date: Jul. 27, 2006

(54) Pet dropping pickup device

(76) Inventor: Vincent Tsai, Taipei (TW)

Correspondence Address: COOPER & DUNHAM, LLP, 1185 AVENUE OF THE AMERICAS, NEW YORK, NY, 10036, US

(21) Appl. No.: 11/333,466

(22) Filed: Jan. 17, 2006

(30) Foreign Application Priority Data
Jan. 25, 2005 (TW) 094201356

(51) Int. Cl. A01K 29/00

(52) U.S. Cl. 294/1.4

(57) ABSTRACT

A pet dropping pickup device has a receiving assembly, a shaft assembly and a guiding assembly. The shaft assembly is retractable and mounted on the receiving assembly. The guiding assembly is mounted inside the shaft assembly and controls the movement of the receiving assembly. The shaft assembly is retractable so that the pet owner can pick up the pet dropping without lowering his/her body when the shaft assembly is extended. Accordingly, the pet dropping pickup device provides a conveniently way to pick up the pet dropping.

### BACKGROUND OF THE INVENTION

1. Field of the Invention

The present invention relates to a pet dropping pickup device, and more particularly to a dropping pickup device that is able to collect pet's dropping in a convenient way.

2. Description of Related Art

Many pet owners especially who like to run their dogs in streets or parks may have a problem of pet dropping. In order to solve the problem of the pet dropping, a conventional pickup device has been provided.

With reference to FIG. 14, a conventional pickup device in accordance with the prior art comprises a first shovel (40) and a second shovel (43).

The first shovel (40) has a front end, a rear end, a receiving recess (41) and a handle (42). The receiving recess (41) is formed at the front end of the first shovel (40). The handle (42) is formed at the rear end of the first shovel (40).

The second shovel (43) is pivotally mounted on the first shovel (40) and has a front end, a rear end, a pushing recess (44) and a handle (45). The pushing recess (44) is formed at the front end of the second shovel (43). The handle (45) is formed at rear end of the second shovel (43).

When the pet owner needs to collect pet dropping, the pet owner can hold and open the conventional pickup device. When the conventional pickup device is closed, the receiving recess (41) of the first shovel (40) and the pushing recess (44) of the second shovel (43) are able to pick up the pet dropping.

However, the dropping is on the ground so that the pet owners need to lower their body position or on their knees to pick up the pet dropping when the pet owners use the conventional pickup device. If the pet owners are elders or difficult to change their body position, the conventional pickup device is very inconvenient in use.

To overcome the shortcomings, the present invention provides a pet dropping pickup device to obviate or mitigate the aforementioned problems.

### SUMMARY OF THE INVENTION

The primary objective of the present invention is to provide a pet dropping pickup device to allow a pet owner to pick up pet dropping in a convenient way.

The pet dropping pickup device has a receiving assembly, a shaft assembly and a guiding assembly. The shaft assembly is retractable and mounted on the receiving assembly. The guiding assembly is mounted inside the shaft assembly and controls the movement of the receiving assembly. The shaft assembly is retractable so that the pet owner can pick up the pet dropping without lowering his/her body when the shaft assembly is extended.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a pet dropping pickup device in accordance with the present invention;

FIG. 2 is an exploded perspective view of the pet dropping pickup device in FIG. 1 when a shell is separated from a base;

FIG. 3 is a perspective view of the pet dropping pickup device in FIG. 1;

FIG. 4 is a side view in partial section of the pet dropping pickup device in FIG. 1;

FIG. 5 is a side view in partial section of the pet dropping pickup device in FIG. 1;

FIG. 6 is an operational side view in partial section of the pet dropping pickup device in FIG. 1 when a trigger is pulled;

FIG. 7 is an operational side view in partial section of the pet dropping pickup device in FIG. 1;

FIG. 8 is a side view in partial section of the pet dropping pickup device in FIG. 1;

FIG. 9 is an operational side view in partial section of the pet dropping pickup device in FIG. 1 when a blade is moved into the base;

FIG. 10 is an operational perspective view of the pet dropping pickup device in FIG. 1;

FIG. 11 is an exploded perspective view of a second embodiment of a pet dropping pickup device in accordance with the present invention;

FIG. 12 is an exploded perspective of a guiding assembly of the pet dropping pickup device in FIG. 11;

FIG. 13 is a side view in partial section of the pet dropping pickup device in FIG. 11; and

FIG. 14 is a perspective view of a conventional pickup device in accordance with the prior art.

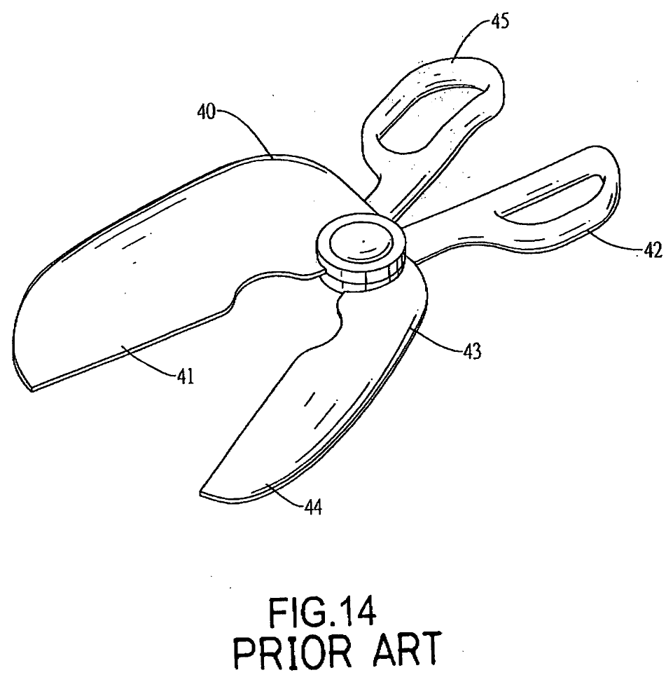

### DETAILED DESCRIPTION OF THE PREFERRED EMBODIMENT

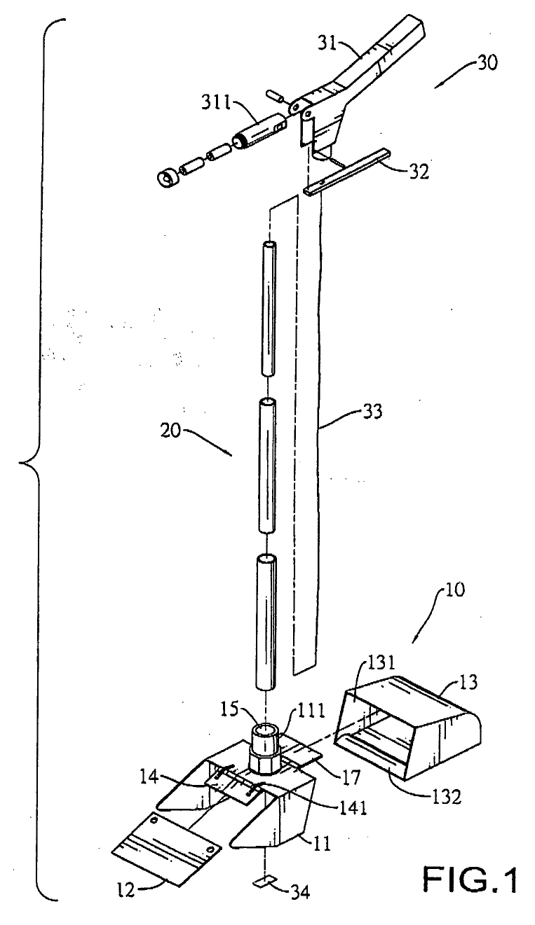

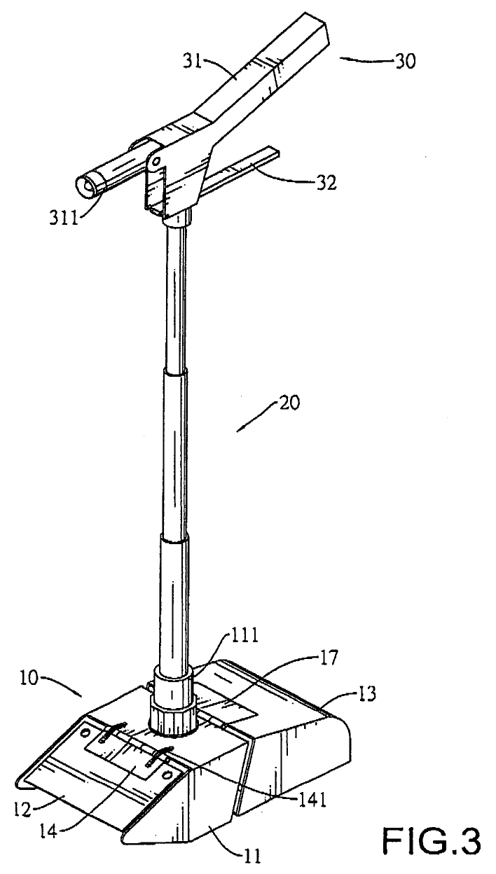

With reference to FIGS. 1, 2, 3, 11 and 13, a pet dropping pickup device in accordance with the present invention comprises a receiving assembly (10)(10A), a shaft assembly (20)(20A) and a guiding assembly (30)(30A).

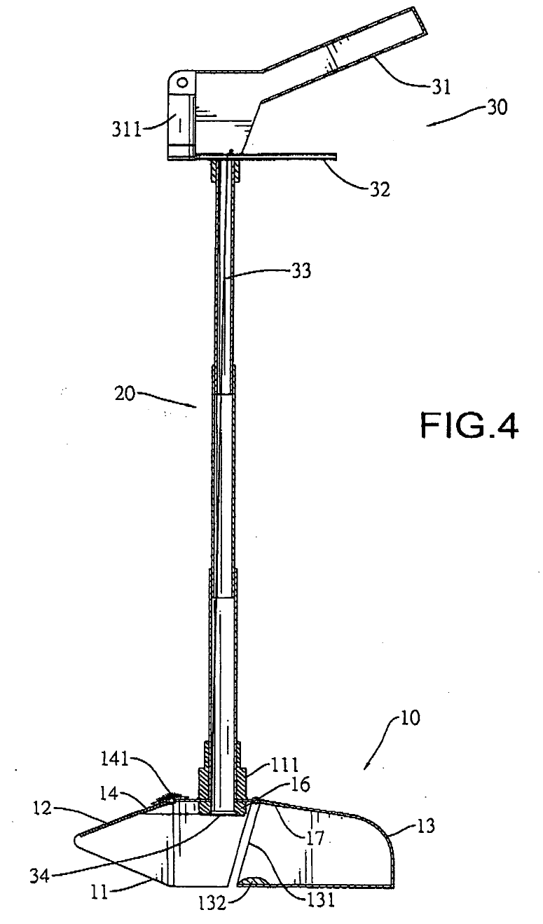

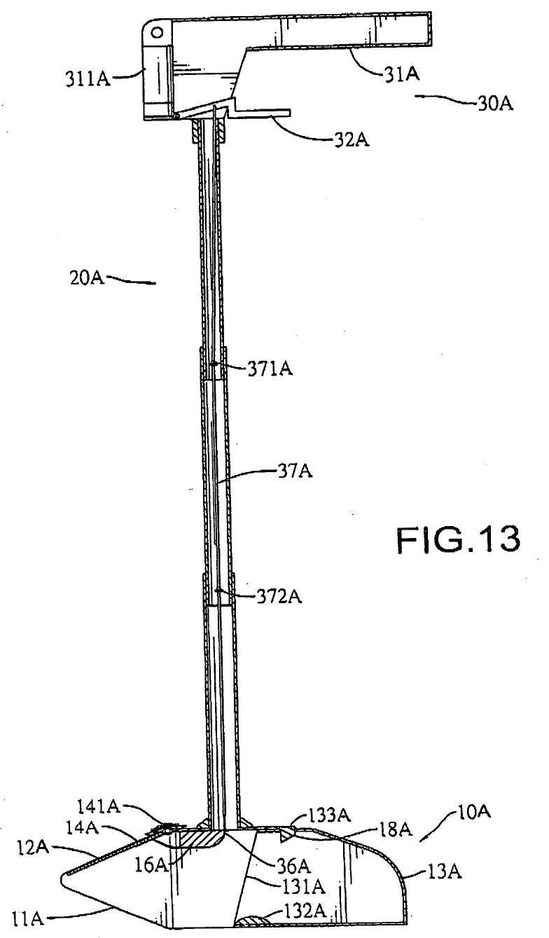

With further reference to FIGS. 4 and 13, the receiving assembly (10)(10A) includes abase (11)(11A), a blade (12)(12A) and a shell (13)(13A). The base (11)(11A) is hollow and has a top, a front end, a rear end, a bottom, an opening, an optional front clip (14)(14A), an optional shaft (111), a top through hole (15)(15A), an optional guide (16)(16A), an optional rear clip (17), an optional top hook (18A), two optional side hooks (19A).

The opening is formed through the front end, the rear end and the bottom of the base (11)(11A) and has an inner surface. The front clip (14)(14A) is pivotally mounted at the front end of the base (11)(11A) and has two top ends, two springs (141)(141A) and a bottom. Each spring (141)(141A) is mounted on one of the top ends of the front clip (14)(14A) and the top of the base (11)(11A). The blade (12)(12A) is secretively clipped to the front clip (14)(14A) of the base (11)(11A).

In a first embodiment of the pet dropping pickup device, the shaft (11) is mounted on and extends up from the top of the base (11). The top through hole (15) is formed through the shaft (111) and the base (11).

The rear clip (17) is pivotally mounted at the top of the rear end of the base (11).

In a second embodiment of the pet dropping pickup device, the top through hole (15A) is formed through the top of the base (11A).

The top hook (18A) is formed at and extends laterally from the top of the rear end of the base (11A). Each side book (19A) is formed at and extends laterally from one side of the rear end of the base (11A).

The guide (16)(16A) is mounted at inner surface of the opening of the base (11)(11A) and near the top through hole (15)(15A) of the base (11)(11A).

The shell (13)(13A) is hollow and has a front end, a top, two sides, a front opening (131)(131A), an optional receiving hole (133A), two optional side recesses (134A) and an optional extension (132)(132A). The front opening (131)(131A) is formed at the front end of the shell (13)(13A) and has a top edge and a bottom.

In the first embodiment of the pet dropping pickup device, the top edge of the front opening (131) is detachably clipped to the rear clip (17) of the base (11).

In the second embodiment of the pet dropping pickup device, the receiving hole (133A) is formed through the top of the shell (13A) and detachably engages with the top hook (18A) of the base (11A). Each side recess (134A) is formed at one side of the shell (13A) and detachably engages with one of the side hooks (19A) on the base (11A).

The extension (132)(132A) is formed at bottom of the front opening (131)(131A) of the shell (13)(13A) and extends up.

The shaft assembly (20)(20A) is hollow, may be retractable and has a top end and a bottom end. The bottom end of the shaft assembly (20)(20A) is mounted in the top through hole (15)(15A) of the base (11)(11A).

The guiding assembly (30)(30A) has a handle (31)(31A) and a pulling device. The handle (31)(31A) is mounted at the top end of the shaft assembly (20)(20A) and has a front end, an optional flash light (311)(311A), a bottom and a trigger (32)(32A).

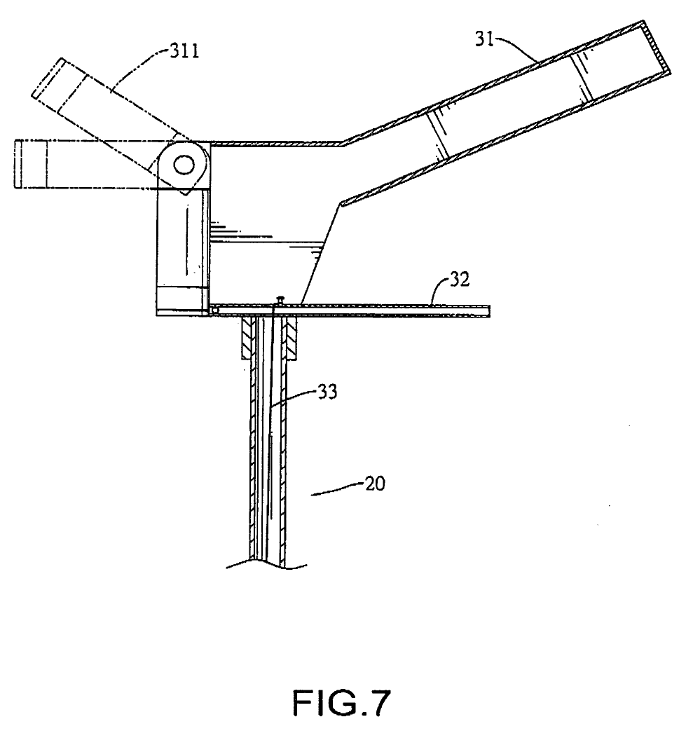

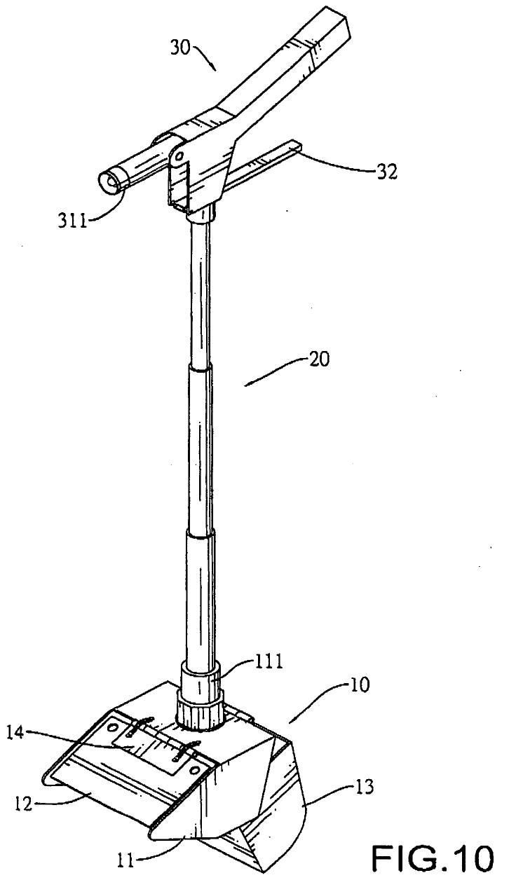

With further reference to FIGS. 7, 10 and 13, the flash light (311)(311A) is pivotally mounted at the front end of the handle (31)(31A) and can be turned on to emit light. The trigger (32)(32A) is pivotally mounted at the bottom of the handle (31)(31A).

With further reference to FIGS. 4 and 13, the pulling device may have a guiding string (33), a cap (34) and a retractable rod assembly (35A).

In the first embodiment of the pet dropping pickup device, the guiding sting (33) has atop end and a bottom end. The top end of the guiding string (33) is connected to the trigger (32). The bottom end of the guiding string (33) extends through the shaft assembly (20), the top through hole (15) of the base (11) and the guide (16) and is connected to the bottom of the front clip (14). The cap (34) is mounted at bottom of the top through hole (15) of the base (11) to prevent the guiding string (33) from falling out of the shaft assembly (20) and into the base (11) when the shaft assembly (20) is retracted.

In the second embodiment of the pet dropping pickup device, the retractable rod assembly (35A) has a top end, a bottom end, a string (36A) and multiple rods (37A). The top end of the retractable rod assembly (35A) is pivotally connected to the trigger (32A). The bottom end of the retractable rod assembly (35A) extends through the shaft assembly (20A) and into the top through hole (15A) of the base (11A). The string (36A) has a top end and a bottom end. The top end of the string (36A) is connected to the bottom end of the retractable rod assembly (35A). The bottom end of the string (36A) extends through the top through hole (15A) of the base (11A) and the guide (16A) and is connected to the bottom of the front clip (14A) of the base (11A).

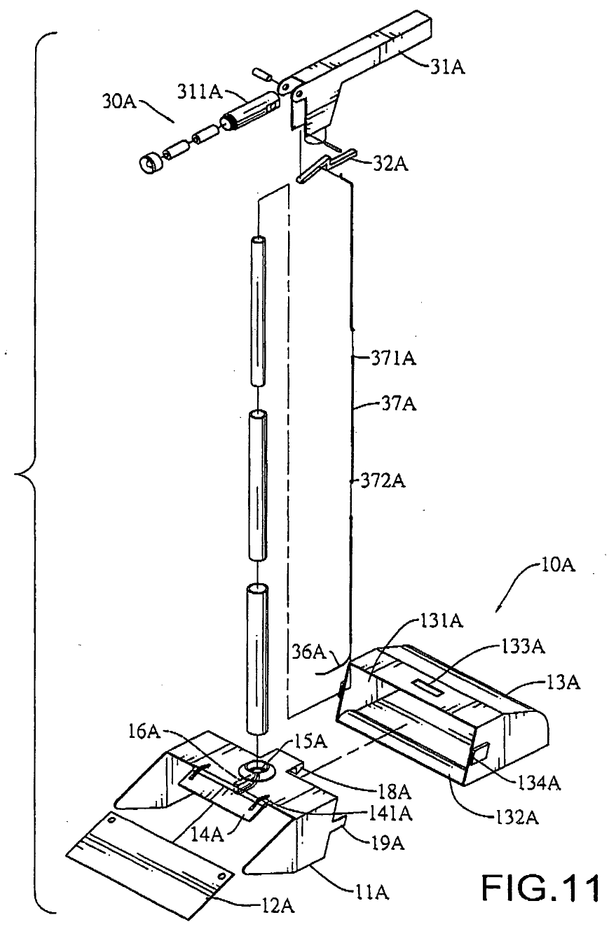

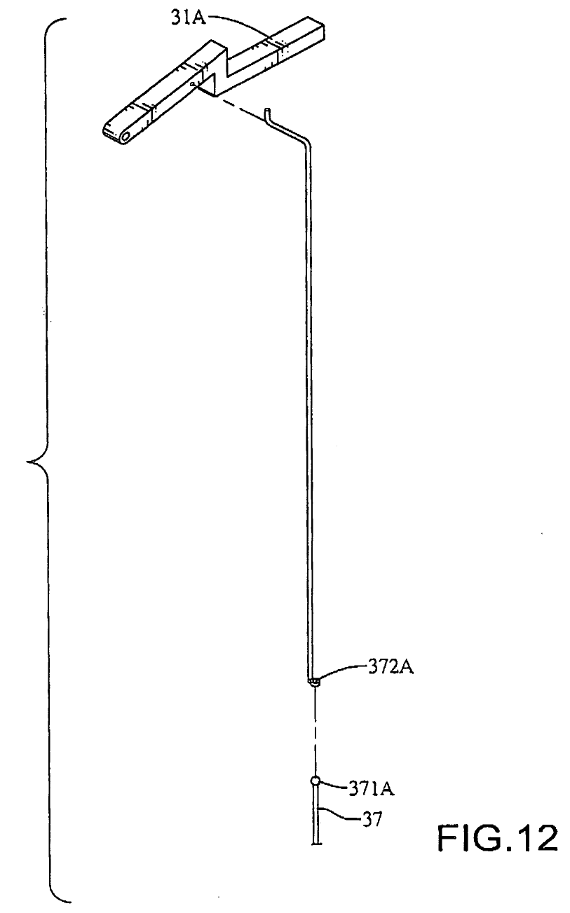

With further reference to FIGS. 11, 12 and 13, each rod (37A) has a top end, a bottom end, a top joint (371A) and a bottom ring (372A). The top joint (371A) is formed at the top end of the rod (37A). The bottom ring (372A) is formed at bottom of the rod (37A) and selectively engages with the top joint (371A) of adjacent rod (37A) so that the rod (37A) are connected to each other. An uppermost rod (37A) is connected to the trigger (32A), and a lowermost rod (37A) is connected to the string (36A).

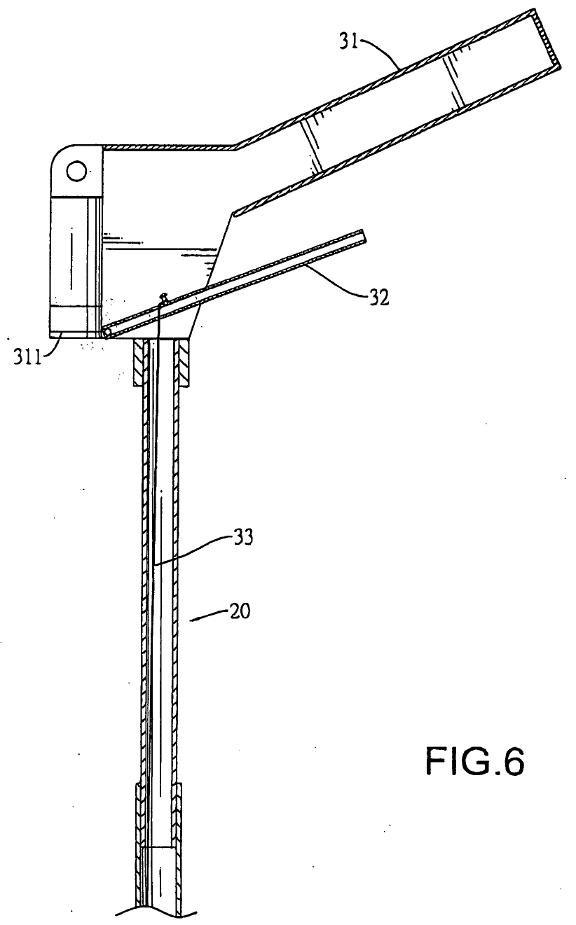

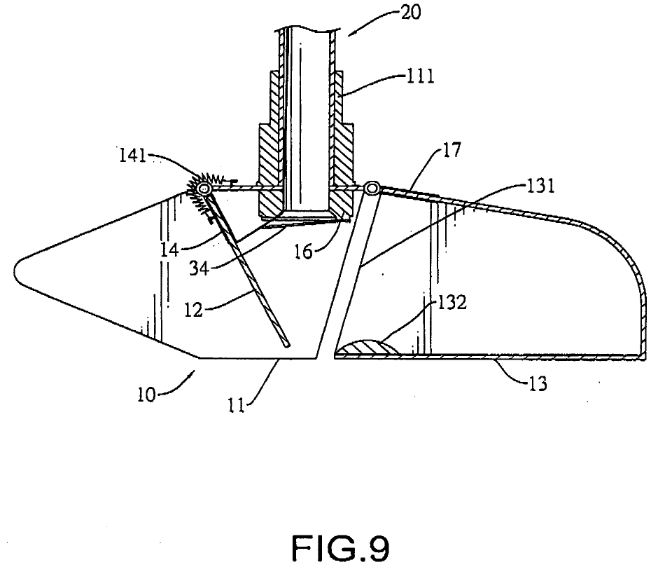

With further reference to FIGS. 6 and 9, when the trigger (32) is pulled, the pulling device pulls the front clip (14) of the base (11) to move toward the base (11). The blade (12) is also moved into the base (11) so that the pet dropping is forced and swept into the shell (13). The extension (132) of the shell (13) is able to prevent the pet dropping from escaping from the shell (13) when the pet dropping is held inside the shell (13).

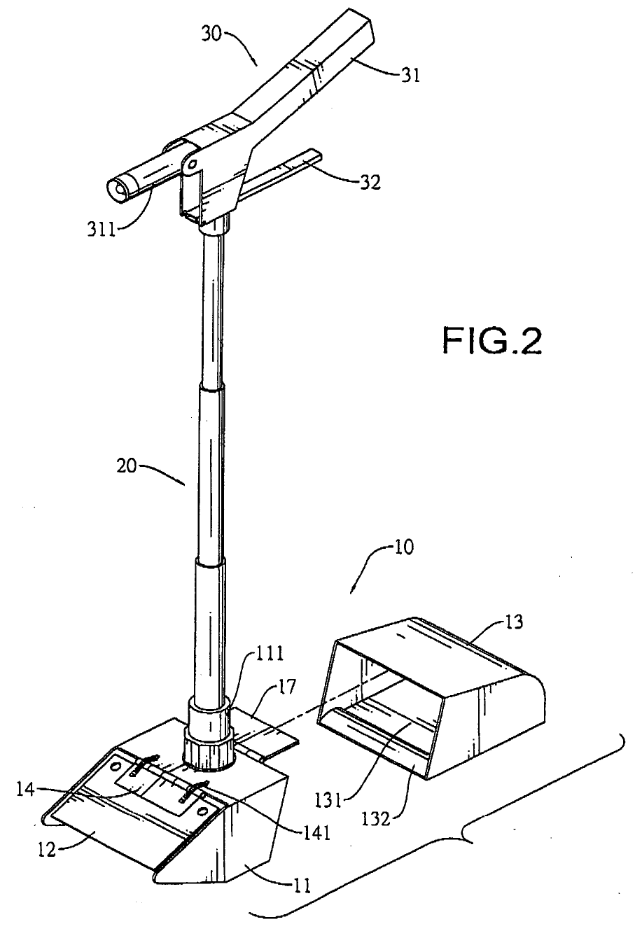

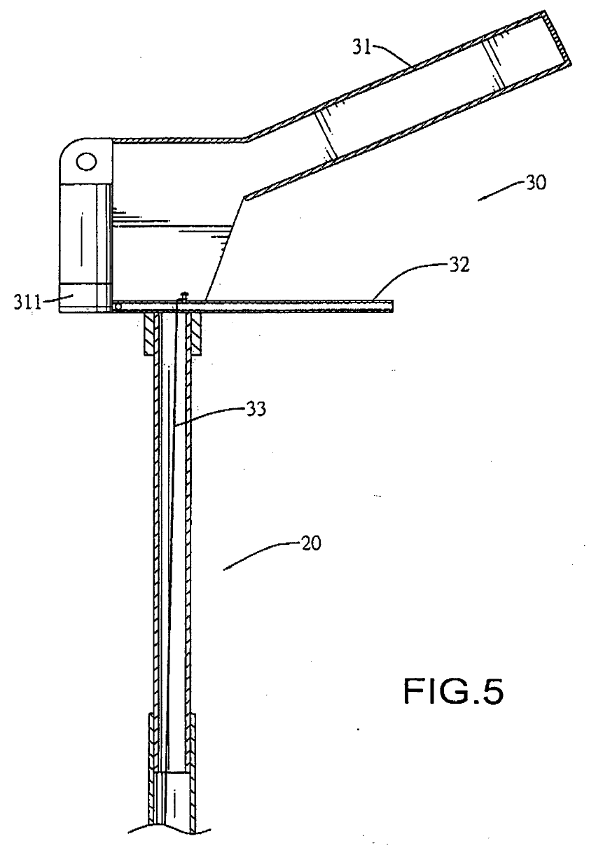

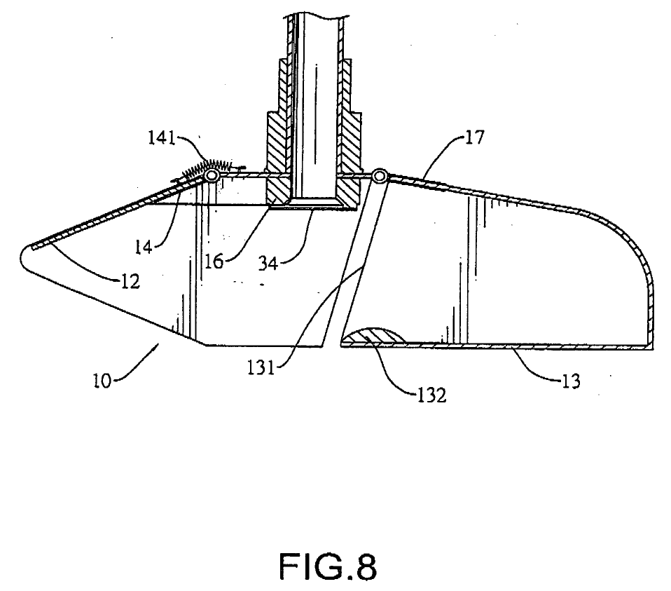

With further reference to FIGS. 4, 5 and 8, after releasing the trigger (32), the two springs (142) force the blade (12) to move back to the original position. With further reference to FIG. 2, a pet owner can dispose of the pet dropping after the shell (13) is separated from the base (11).

Because the shaft assembly (20)(20A) is retractable so that the pet owner does not need to change any body position to pick up the pet dropping when the shaft assembly (20)(20A) is extended. For these elder pet owners, the pet dropping pickup device of the invention provides a conveniently way to pick up the pet dropping.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A pet dropping pickup device comprising:
a receiving assembly having
a base being hollow and having
a top;
a front end with a top;
a rear end with a top;
a bottom;
an opening formed through the front end, the rear end and the bottom and having an inner surface
a top through hole formed through the base; and
a blade pivotally mounted at the top of the front end of the base; and
a shell detachably mounted at rear end of the base and having
a front end;
a top;
two sides;
a front opening formed at the front end of the shell and having
an edge; and
a bottom;
a shaft assembly being hollow, connected to the receiving assembly and having
a top end; and
a bottom end mounted in the top through hole of the base; and
a guiding assembly having
a handle mounted at the top end of the shaft assembly and having
a front end;
a bottom; and
a trigger pivotally mounted at the bottom of the handle; and
a pulling device extending through the shaft assembly and connected between the blade of the base and the trigger of the handle.

2. The pet dropping pickup device as claimed in claim 1, wherein the shaft assembly is retractable.

3. The pet dropping pickup device as claimed in claim 2, wherein the base has a front clip pivotally mounted at the front end of the base and detachably clipped the blade to the base and having two top ends, two springs each mounted between one of the top ends of the clip and the top of the base and a bottom.

4. The pet dropping pickup device as claimed in claim 3, wherein the base further has a shaft mounted on and extending up from the top of the base; and
a rear clip pivotally mounted at the top of the rear end of the base and detachably clipped the shell to the base,
wherein the top through hole is formed through the shaft of the base.

5. The pet dropping pickup device as claimed in claim 4, wherein the base further has a guide mounted at an inner surface of the opening of the base and near the top through hole of the base.

6. The pet dropping pickup device as claimed in claim 5, wherein the pulling device has a guiding string having a top end connected to the trigger of the handle and a bottom end extending through the shaft assembly, the top through hole of the base and the guide and connected to the bottom of the front clip.

7. The pet dropping pickup device as claimed in claim 6, wherein the pulling device further has a cap mounted at a bottom of the top through hole of the base.

8. The pet dropping pickup device as claimed in claim 7, wherein the handle of the guiding assembly further has a flash light pivotally mounted at the front end of the handle.

9. The pet dropping pickup device as claimed in claim 2, wherein the base has a top hook formed at and extending out from the top of the rear end of the base and two side hooks respectively formed at and extending out from the sides of the rear end of the base;
the shell has a receiving hole formed through the top of the shell and detachably engaging with the top hook of the base and two side recesses respectively formed at the sides of the shell and detachably engaging with the side hooks of the base, respectively.

10. The pet dropping pickup device as claimed in claim 9, wherein the base further has a guide mounted at an inner surface of the opening of the base and near the top through hole of the base.

11. The pet dropping pickup device as claimed in claim 10, wherein the pulling device has
a retractable rod assembly having a top end pivotally connected to the trigger and a bottom end extending through the shaft assembly and toward the top through hole of the base; and
a string having a top end connected to the bottom end of the retractable rod assembly and a bottom end extending through the top through hole of the base and the guide and connected to the bottom of the front clip of the base.

12. The pet dropping pickup device as claimed in claim 11, wherein the pulling device further has multiple rods, each rod has a top end, a bottom end, a top joint formed at the top end of the rod and a bottom ring formed at bottom of the rod and engaging with the top joint on an adjacent rod so as to connect the rods together,
wherein an uppermost rod is connected to the trigger and a lowermost rod is connected to the string.

13. The pet dropping pickup device as claimed in claim 12, wherein the handle of the guiding assembly further has a flash light pivotally mounted at the front end of the handle.
